(19) United States
(12) Patent Application Publication
(10) Pub. No.: US 2012/0226650 A1
(43) Pub. Date: Sep. 6, 2012

(54) Black Box Innovation, Systems and Methods

(76) Inventor: Nicholas Witchey, Laguna Hills, CA (US)

(21) Appl. No.: 13/411,984

(22) Filed: Mar. 5, 2012

Related U.S. Application Data
(60) Provisional application No. 61/448,842, filed on Mar. 3, 2011.

(51) Int. Cl. G06N 5/02; G06F 17/30

(52) U.S. Cl. 706/50

(57) ABSTRACT

An innovation expert system is presented. The expert system can include one or more reasoning engines capable of generating a hypothesis representing a possible path for innovation between a concept and a technological class. The hypothesis can be validated to some extent by analysis or simulation.

This application claims the benefit of priority to U.S. provisional application having Ser. No. 61/448,842 filed on Mar. 3, 2012. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is automated reasoning technologies.

### BACKGROUND

As technology advances, the innovation landscape shifts rapidly where a single inventor or organization has difficulty in keeping abreast of new concepts. Furthermore, inventive entities have difficulty identifying possible free areas or fertile ground for new concepts. Ideally, the inventive entity should be able to quickly generate or mine possible avenues of innovation along lines previously unconsidered or non-obvious. Unfortunately, known efforts for automating creativity are hopelessly bound to digital, logical rails in capable of making leaps beyond digital boundaries.

What has yet to be appreciated is fertile innovative ground can be found by applying one or more reasoning techniques capable of breaking out of the hard coded digital box. For example, as described herein reasoning techniques can be applied to known invention-related literature to generate non-obvious hypotheses relating to possible avenues for innovation. The generated quantified hypotheses can lack necessary or sufficient logical reasoning while still remaining valid. Though application of such reasoning techniques, one can discover new avenues of thought according to very specific paths that would ordinarily be outside the scope of a reasonable person having ordinary skill in the art.

Others have applied varying reasoning techniques for scientific purposes as described in the paper titled “The Automation of Science”, King et al., Science 3 Apr. 2009: Vol. 324 no. 5923 pp. 85-89. King's disclosed robot successfully applied reasoning techniques to make several new discoveries. Interestingly, such techniques have yet to be applied to innovation, especially with respect to reviewing existing patent databases.

Quite a bit of effort has been directed to generation or analysis of concept maps in general. The following references represent example effort directed to use of concept maps for various markets:
U.S. Pat. No. 5,506,937 to Ford titled “Concept Mapbased Multimedia Computer System for Facilitating User Understanding of a Domain of Knowledge”, filed Apr. 2, 1993;
U.S. Pat. No. 7,249,117 to Estes titled “Knowledge Discovery Agent System and Method”, filed May 21, 2003;
U.S. Pat. No. 7,447,665 to Murray titled “System and Method of Self-Learning Conceptual Mapping to Organize and Interpret Data”, filed May 10, 2005;
U.S. Pat. No. 7,765,097 to Yu et al. titled “Automatic Code Generation via Natural Language Processing”, filed Mar. 20, 2006;
U.S. Pat. No. 8,112,384 to Mitra et al. titled “System and Method for Problem Solving Through Dynamic/Interactive Concept-Mapping”, filed Oct. 25, 2005;
U.S. patent application publication 2005/0154701 to Parunak et al. titled “Dynamic Information Extraction with Self-Organization Evidence Construction”, filed Dec. 1, 2004; and
U.S. patent application publication 2005/0240583 to Ki et al. titled “Literature Pipeline”, filed Nov. 23, 2004.

Of particular interest, further progress has been made in patent analysis as described in U.S. patent application publication 2010/0287478 to Avasarala et al. titled “Semi-automated and Inter-active System and Method for Analyzing Patent Landscapes”, filed May 11, 2009. Avasarala describes creating a patent landscape based on conceptual regions, which allows for competitive analysis of patents. Although useful for analyzing patent landscapes according various patent attributes, Avasarala fails to provide an augmented path toward innovation. For example, Avasarala fails to appreciate that a white-space map can be created where the map itself has quantified, or well defined, white-space regions. Rather, Avasarala merely seeks to compare nodes or node links without providing concrete direction on a path of innovation.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for augmented innovation techniques.

### SUMMARY OF THE INVENTION

The inventive subject matter provides apparatus, systems and methods in which one can apply reasoning techniques within a digital environment to generate one or more possible correlations among innovative concepts relative to possible patent claims. One aspect of the inventive subject matter includes an expert system configured to infer possible hypotheses representing a path of innovation between patent concept maps and technological classes. Through application of reasoning techniques, new fertile grounds for innovation can be identified quickly. The expert system can include a patent database storing objects representing concept maps associated with a plurality of patents where the concept maps represent subject matter of the patent specifications. The expert system can also include a reasoning engine coupled with the database. The reasoning engine can derive one or more correlations between the concept maps and technological classes associated with the patents. Although the correlations are useful information, the reasoning engine can further review the concept maps to search for similar concept maps lacking correlations with technological classes. The reasoning engine can be configured to infer a possible correlation (i.e., a hypothesis, suggestion), that might be an area of among uncorrelated concept maps and technological class. The inference can be achieved through application of one or more reasoning techniques including deductive reasoning, adductive reasoning, or inductive reasoning.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of an innovation expert system.

FIG. 2 presents an example quantified white-space map including clusters of concept maps.

### DETAILED DESCRIPTION

It should be noted that while the following description is drawn to a computer/server based expert system, various alternative configurations are also deemed suitable and may employ various computing devices including servers, generators, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including an infrastructure capable of interfacing with one or more innovation submission engines.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the scope of this document “coupled to” and “coupled with” are also considered to mean “communicatively coupled with” over a network, possibly via one or more intermediary networking devices.

The reader should appreciate the disclosed inventive subject is considered to include discovering correlations among known inventive concepts derived from patents, patent application, or claimable subject matter. The term “patent” is used euphemistically to represent a published disclosure regarding an innovation, preferably a patent document from a patent office. Furthermore the inventive subject matter also includes discovering areas that lack correlations. In a patent cluster map, the correlations would represent areas of high density of patents, possibly represented as a peak or an island in the map. Areas lacking correlations can be represented by bays or “white-space”. When a patent map is well-defined or quantification, the quantified white-space represents possible opportunities for innovation.

White-space can be identified by quantifying the space in which a patent map is constructed. Rather than merely clustering patent concepts together based on programmatic relationship, one can also cluster the patents based on related concepts as applied to defined technological classes. Fortunately, the various patent offices around the world categorize patents based on well-defined technological class. One can also utilize a proprietary technological class system.

The white-space can be quantified by creating a two, three, or higher dimensional graph where each axis of the graph represents a technological class. For example, a graph could include UPSPTO class 705 (i.e., DATA PROCESSING: FINANCIAL, BUSINESS PRACTICE, MANAGEMENT, OR COST/PRICE DETERMINATION) versus USPTO class 345 (i.e., COMPUTER GRAPHICS PROCESSING AND SELECTIVE VISUAL DISPLAY SYSTEMS). Each axis can be further broken down by subclass. Perhaps the graph might have thousands, tens of thousands, or more cells where each cell has a defined meaning by the class/subclass combinations. Concepts, concept maps, concept map objects, or concept map clusters generated from patents can then be plotted on the graph according to the classes associated with the originating patents. The resulting clusters indicate where current concepts fall in the quantified map, and the remaining white-space indicates where patent-related concepts are lacking. Thus, the quantified white-space graph provides instructive or directed insight into the meaning of the white-space.

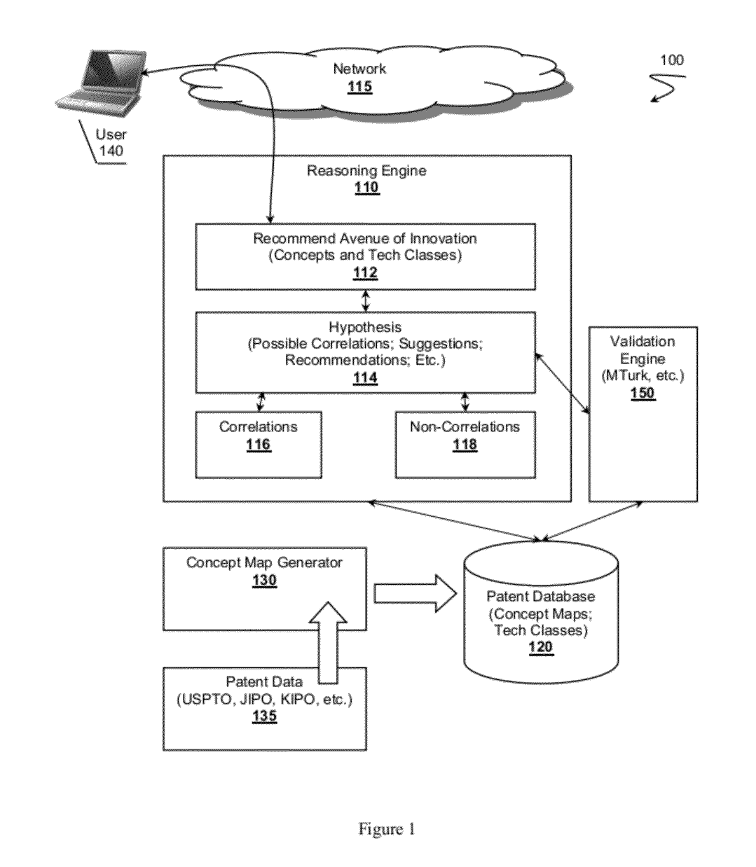

In some embodiments, as illustrated in FIG. 1, an innovation expert system 100 can be constructed based on one or more components that work together over a network 115. The expert system 100 can include a patent database 120 storing concept maps associated with a plurality of patents where the concept maps can be generated according to one or more desirable techniques. Example concepts maps can include semantic maps or “brains”, cluster maps, cloud maps, neural networks, or other types of maps. One should appreciate that the concept maps are considered distinct manageable objects stored within patent database 120. Further, each concept map can comprise a plurality of concept attributes describing the nature of the corresponding concepts.

Consider an example of a concept map associated with silicon chips. The silicon chip concept map can include attributes describing such chips, perhaps including attributes like: material: Si; material: GaAs; process: 18 nm; or other attributes. One should appreciate that such attributes are illustrative only. Each concept map could include hundreds, thousands, or more attributes across a broad spectrum of information.

Patent database 120 can also include information related to the technology class from patent offices. Technology classes represent a codification scheme identifying patent claimable subject matter or disclosure. In a preferred embodiment, the technology classes map to the classes offered by the United States Patent and Trademark Office (USPTO). One should appreciate the technology classifications provided by various patent jurisdictions gives rise to a quantified representation of a white-space.

Concept maps can be constructed from a concept map generator 130 through application of one or more AI algorithms possibly comprising binary decision trees, genetic algorithms, semantic analysis, simulated annealing, case-based reasoning, or other known or yet to be inventive algorithms. The algorithms preferably are constructed to analyze patent specifications to search for related concepts based on a semantic analysis of the specifications. As the algorithms analyze patent documents, the statistics associated with a concept map increases, thus increasing the confidence that a concept map is well founded. An acceptable technique for constructing patent concept maps includes applying Latent Semantic Analysis. For example, the techniques described in “A Semantic Analysis Method for Concept Map-based Knowledge Modeling” to Hao et al. (2010). The concept maps can be heavily influenced by the specification of the patents, where at least in the United States technological classes can be heavily influenced by patent claims.

The expert system 100 can further include a reasoning engine 110 capable of comparing the concept maps to technological classes, possibly via one or more comparable concept map attributes. Through the comparison, reasoning engine 110 can establish one or more correlations 130 among concept map objects and technology class indicating that a concept map is related to a technological class. For example, in some embodiments, the concept maps include attributes indicating which patents gave rise to the concepts. The attributes can be used to identify into which tech classes the corresponding patents were placed (e.g., US classification, field of search, etc.). In other embodiments, the technology classes can be analyzed according to the same algorithms used to analyze the patents. The result is a set of class-based concept maps for the tech classes where the tech class concept maps can also include attributes adhering to the same namespace as the patent concept maps' attributes. Thus, reasoning engine can simply map from concept maps to technology classes directly or indirection through the attribute namespace.

One can consider establishing the correlations 130 as identifying peaks or clusters of concept maps around technology classes. Reasoning engine 110 can further infer a hypothesis 114 representing a possible correlation, or a suggestion, that might be an area of innovation among concept maps and technological class where there is an apparent white-space, at least to within a selection criteria or threshold. Thus, reasoning engine 110 also seeks to identify concept maps that have non-correlations 118 to technology classes. The reader should consider this subtle point because concepts map objects are compared to generate quantified white-space rather than mapping patents directly to technology classes or into clusters strictly based on concepts.

The inference can be based on applying one or more reasoning techniques including deductive reasoning, abductive reasoning, inductive reasoning, fuzzy log, perturbation theory, or other types of reasoning based on similarity among concept maps. Using a combination of one or more types of reasoning techniques allows the reasoning engine 110 to make a leap across concept maps to generate a hypothesis that might not make logical sense. When a hypothesis is generated, the reasoning engine can present the hypothesis as a possible recommendation or suggestion for further innovative exploration.

In view that concept maps can have graphical connections or relationship information, possibly represented by attributes, reasoning engine 110 can search for concept maps that are similar in nature. Two concept maps can be considered similar if they have similar structures (e.g., graphical representations, ontologies, key word or terms, attributes, etc.). For example, a magnet concept and a hook and loop fastener concept would have some similarity because both concepts relate to methods of joining components together even though the two items are quite different. In a more extreme example, reasoning engine 110 might generate a hypothesis that concept maps related to potato chips could be related to CPU production tech classes because silicon microchips have established correlations 116 with such classes. One should appreciate that the resulting hypothesis is considered to be a recommendation 112 on a possible avenue of innovation to be considered by user 140.

An astute reader will appreciate that some technological fields are quite distant from other technological fields (e.g., semiconductors versus shoe laces). There are at least two perspectives to be considered with respect to such disparity. First, bridging between disparate fields can yield unintended insights that one skilled in the art would not find obvious to try, thus leading to patentability. Second, the initial inputs to the expert system 100 can be narrowed as desired, possibly by filtering inputs based just on class or subclass so the corpus of patents fall within the same space, at least at some level.

The expert system 100 can also utilize the patents as a validation mechanism. For example, the system can further include a validation engine 150 that can partition a patent database 120 into groups where an analysis is run against a first group of patents then the resulting hypotheses 114 are compared against the correlations 116 of the second group.

There can be at least two types of validations of a hypothesis 114. First, the hypothesis 114 might still lack a correlation (i.e., non-correlation 118) in the second group, which could validate or at least indicate there is fertile ground for innovation. Second, the hypothesis 114 might indicate there is actually a correlation 116 within the second group, which could validate the analysis as viable or indicate prior art. Such an approach is considered advantageous by partitioning patents in the patent database by time. Perhaps a first decade of patents can be compared to a second decade of patents. One can consider comparing a hypothesis 114 to correlations 116 in other sets of patents as an experimental validation of a hypothesis. Through a validation, the validation engine 150 can generate a relative merit associated with the hypothesis 114, which can be used to adjust a ranking, up or down, of the hypothesis relative to other hypotheses or correlations according to a score. The score can be calculated through various techniques, possibly based as an normalized value corresponding to the number of patents that contribute to the hypothesis 114.

Yet another type of validation engine 150 could include a Monte Carol engine where validation engine 150 runs multiple analyses on different sets of patent literature. For example, reasoning engine 110 operating as validation engine 150 could select a relatively small number of patents to conduct a first analysis to generate hypothesis 114. The reasoning engine 110 then runs another analysis on a different subset of patents (overlapping or non-overlapping), then another, then another, and soon on to build up statistics associated with the hypothesis or multiple hypotheses 114. A Monte Carlo might involve thousands of runs across thousands of different sets of patents. The result is confidence score or relative metric score associated with hypothesis or hypotheses 114 derived from the Monte Carlo statistics.

Validation engine 150 can be implemented according to various techniques. As discussed above, reasoning engine 110 could operate as a validation engine 150 by segregating the concept map objects and conducting separate analyses, then comparing the results. In other embodiments, validation 150 can include a Mechanical Turk (MTurk) infrastructure. For example, hypotheses 114 could be submitted to Amazon's® MTurk engine (see URL www.mturk.com) where workers are requested to submit suggestions on how to map the concept map objects to a suggested technology class. The suggestions can then be further reviewed or ranked by one or more evaluation criteria. Other workers could rank the merit of the suggestions, which gives rise to merit score for the hypothesis.

Contemplated patent databases 120 can store concept maps, tech classes, patents, or other patent related information according to a jurisdiction agnostic format. For example, patents data 135 can originate from Japan, Korea, China, or other countries and can be analyzed in a language independent manner (e.g., XML, metadata, etc.). Furthermore, the concept maps can be normalized according to a common intermediary structure to ensure patents, and technology classes for that matter, can be compared with each other. As discussed previously, the patent concept maps or technology classes can be mapped to a common intermediary attribute namespace allowing for easy comparison among objects in the system.

Recommendations 112 can be presented through various techniques. In some embodiments, recommendations 112 can take on the form of a quantified “white-space” map where hypotheses 114 are clustered around technology class number. Such an approach is different than known techniques (e.g., Thompson® ThemeScapes®) because the field or white-space is quantified and has real meaning. Such white-space maps could be considered an inverse topological map of sorts where shallows with clusters indicate possible areas to innovate. It is also contemplated that recommendations 112 can simply be presented with a concept map definition along with ranked technological class definitions. User 140 can review the technology class definitions to determine if applying the class definition to the current concept of interest would have merit.

Expert system 100 is presented as an over-the-internet service. However, other embodiments are also possible. For example, the service could be provided in exchange for a fee or subscription price. Alternatively, the Expert system 100 could include one or more modules that can be installed on computing device local to user 140.

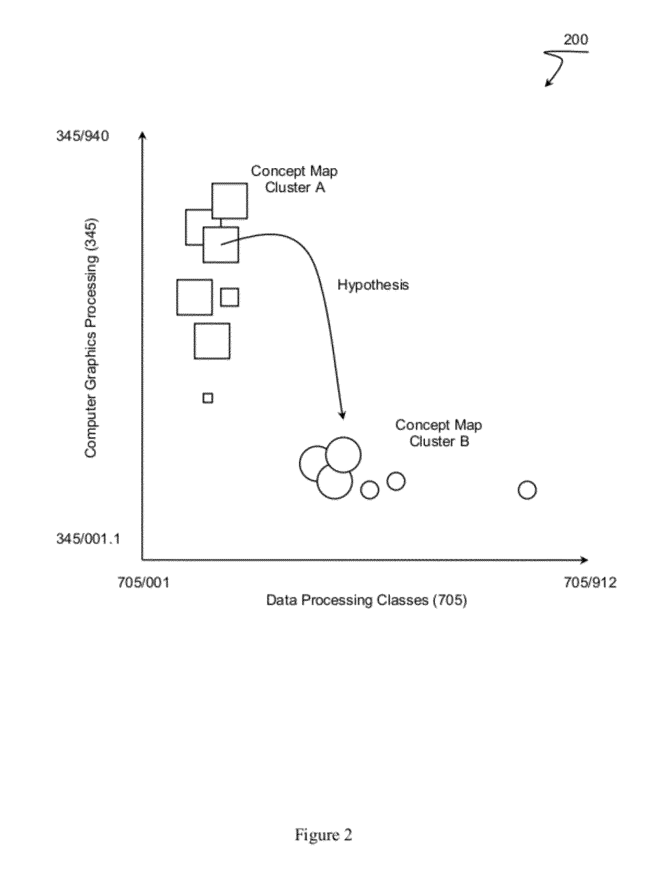

FIG. 2 provides an example quantified white-space map 200 that compares data processing classes (USPTO class 705) and subclasses to graphics processing (USPTO class 345) classes and subclasses. Although map 200 is presented in a two dimensional format, one should appreciate that any number of dimensions can be evaluated by the expert system. Further, each of the data items (i.e., circles and squares) representing one or more concept map objects plotted on the graph, where each concept map object can be considered an N-tuple allowing for analysis according to the attributes associated with each of the objects.

Map 200 is quantified in the sense that each location on the map has a specific meaning according to the corresponding technology class definitions. In the example, each concept map object is plotted in cluster A or cluster B. The size of the data items can correspond to the number of concept maps falling within the “cells” of the map 200. Further, each of the concept map objects or groups of concept map objects can be presented as nodes in a linked graph. Example techniques for creating concept map nodes that could be suitably adapted for use with the inventive subject matter can be found in U.S. patent application publication 2010/0287478 to Avasarala et al. titled “Semi-automated and Inter-active System and Method for Analyzing Patent Landscapes”, filed May 11, 2009.

Clusters A and B of concept maps objects, and their corresponding concepts, are illustrated as having correlations with respective classes. However, the clusters relatively lack correlations with respect to the other's classes. Consider that cluster A is heavily weighted toward the low end of class 705 while being spread over the high end of class 345, but relatively lacks a correlation with the high end of class 705. The reasoning engine seeks to discover the correlations of one or more concept map objects with technology classes, then seeks other concept map objects or clusters having some form of similarity. In the example shown, the reasoning engine applies the various reasoning techniques to attributes of the concept map objects of cluster A as compared to attributes of concept map objects in cluster B. The rules applied can include seeking similar groupings of key words, attributes, concept map shapes, cluster shapes, concept map node structures, node links, or other criteria for establishing a similarity. If the reasoning engine establishes, to within a confidence level derived according the rules, that a similarity exists between the features of cluster A and the features of cluster B, then the reasoning engine can generate a hypothesis that the concept map objects associated with cluster A should be further reviewed with respect to the technology classes associated with cluster B.

The hypothesis can take on many different forms. In some embodiments, the hypothesis can be presented as a quantified white-space map as illustrated, possibly as a cloud plot or with contours showing confidence level of the hypotheses with respect to technology classes. In other embodiments, the hypothesis can include a recommendation of a specific binding of a concept map object with a technology class definition.

To continue the example shown in FIG. 2, consider a concept map clustering related to providing rendered details on an imaged surface nominally associated with class 345/428 and a concept map clustering related to licensing data nominally associated with class 705/059. The reasoning engine might establish a similarity among the clusters' features and generate a hypothesis or suggestion that claims could be drafted around binding rendering detail to the class definition of 705/059 “ . . . wherein a determination is made that an outside entity has authorized the use of the selection”. Thus, the hypothesis can include a very specific, quantified, and concrete recommendation. In this example, the path of innovation would likely be associated with presenting a rendered object according to a licensed level associated with a display resolution based on a license obtained from an outside entity or third party. A follow-on analysis using similar techniques can then be used to determine market relevance of the recommendation.

The example presented above and map 200 are simple examples. One should appreciate that the reasoning engine can conduct an analysis across many dimensions rather than just two as presented in map 200. For example, the reasoning engine might establish that a correlation between a clustering of concept map objects and technology classes might be a function of two more technology classes. When the reasoning engine identifies similarity among clusters, then the hypothesis could include a recommendation or suggestion that an avenue of innovation for a non-correlated concept map object should follow more than one technology class. Therefore the inventive subject matter is considered to include a hypothesis comprises two or more technology classes, possibly widely distinct technology classes.

Although the disclosed techniques focus on patent analysis, one should appreciate the concept maps can also be generated for other forms of publications. For example, the concept map generator could analyze web postings, news papers, television programs, radio feeds, to generate concept maps representing of buzz or published marketing information. Such non-patent literature can then be compared to technological classes to identify possible avenues of innovation.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An innovation expert system comprising:
A patent database storing one or more patent concept map objects representing a concept map associated with patent literature; and
A reasoning engine configured to:
derive correlations between the concept map objects and patent technology classes associated with the plurality of patents;
infer a quantified hypothesis representing a suggestion that at least one of concept map objects could relate to a technology class according to a confidence level as a function of similar concept maps objects and where the at least one concept map object relatively lacks a derived correlation with the technology class; and
present the hypothesis as a recommended avenue of innovation.

2. The expert system of claim 1, wherein the reasoning engine is configured to apply at least one of deductive, adductive, and inductive reasoning to infer the hypothesis.

3. The expert system of claim 1, wherein the reasoning engine is further configured to compare multiple hypothesis with respect to the correlations to derive a ranking.

4. The expert system of claim 1, further comprising a validation engine configured to compare the hypothesis against a first correlation derived from a second, different plurality of patents and to generate a relative merit of the hypothesis relative to the first correlation.

5. The expert system of claim 4, wherein the validation engine is further configured to adjust a ranking of the hypotheses based on the relative merit.

6. The expert system of claim 1, wherein the hypothesis is presented as a quantified white-space map.

7. The expert system of claim 1, wherein the plurality of patents comprises patents from differing jurisdictions.

8. The expert system of claim 7, wherein the concept map objects comprises jurisdiction agnostic concept maps.

9. The expert system of claim 8, wherein the concept map objects are stored according to a normalized concept map structure.

10. The expert system of claim 1, further comprising a concept map generator configured to generate the concept map objects based on applying an artificial intelligence (AI) algorithm to the plurality of patents.

11. The expert system of claim 10, wherein the AI algorithm include at least one of the following case-based reasoning, simulated annealing, semantic analysis, and genetic algorithms.

12. The expert system of claim 1, wherein the hypothesis comprises a recommended mapping of the at least one concept map object to a technology class definition.
